(19) United States
(12) Patent Application Publication
(10) Pub. No.: US 2007/0024011 A1
(43) Pub. Date: Feb. 1, 2007

(54) Thermally stable vacuum enclosure seal design for CO2 lasers

(76) Inventors: Raymond Michaud, Lebanon, CT (US); Thomas V. Hennessey JR., Lebanon, CT (US); Lanny Laughman, Bolton, CT (US)

Correspondence Address: STALLMAN & POLLOCK LLP, 353 SACRAMENTO STREET, SUITE 2200, SAN FRANCISCO, CA, 94111, US

(21) Appl. No.: 11/481,309

(22) Filed: Jul. 5, 2006

Related U.S. Application Data
(60) Provisional application No. 60/703,592, filed on Jul. 29, 2005.

(51) Int. Cl. F16J 15/00; F16J 3/00

(52) U.S. Cl. 277/628

(57) ABSTRACT

A tongue and groove design provides a thermally stable hermetic seal for a laser housing. A sealant, such as a metal o-ring, is placed between the tongue of a flange member, or end piece, and a groove formed in an open end of a housing to provide a hermetically sealed environment. The groove can be a double groove, having a wider first portion and a narrower second portion. The sealant can be placed in the narrower second portion such that when the tongue is placed at least partially within the narrower second portion, the sealant fills the space between the tongue and groove.

### RELATED APPLICATION

This application claims the benefit of U.S. Provisional Application No. 60/703,592, filed on Jul. 29, 2005, by Michaud et al., and titled “Thermally Stable Vacuum Enclosure Seal Design For CO₂ Lasers.” U.S. Provisional Application No. 60/703,592 is hereby incorporated by reference herein in its entirety.

### TECHNICAL FIELD OF THE INVENTION

The present invention relates to laser systems, and more specifically, to systems and methods for providing a hermetically sealed environment for laser operation.

### BACKGROUND

As shown in FIG. 1, certain existing RF-excited CO₂ lasers utilize a housing, such as an aluminum extrusion 10, to contain the RF electrodes and inductors (not shown), as well as the laser gas mixture. The aluminum extrusion 10 typically is in the shape of a circular tube, a hollow rectangle or square bar-like configuration. The extrusion 10 is capped at each end with an aluminum mirror holding end flange 12, to which angular adjustable reflecting mirror(s) and an output coupling mirror are attached. A reflecting mirror 14 is shown in FIG. 1A. Those skilled in the art will appreciate that the output coupling mirror is attached on the end flange 12 located on the opposite end of the laser metal extrusion housing 10 and is, therefore, not shown in FIG. 1A. These mirrors form the laser's optical resonator. As stated above, also contained within the gas plenum chamber 13, but not shown in FIG. 1A, are RF electrodes that create the plasma and inductors that are distributed down the length of the electrodes, as is well known in the art of diffusion cooled, sealed off, RF excited CO₂ lasers. As further shown in FIG. 1A, metal o-rings 16, e.g., Indium o-rings, are placed between the extrusion 10 and the end flanges 12 in order to form a hermetically sealed enclosure. The enclosure then serves as a sealed, vacuum cavity (gas plenum) laser housing 13, with the reflecting mirrors forming the laser resonator. The mirrors 14 are mounted on a metal holding post that is machined directly into the respective end flange 12. Each mirror 14 is held in place by a side compression ring spring machined directly into the end of the post. The mirror holding posts are held in place by machining a tuning flexure or flexible member 15 between the post and the rest of the flange body. This design helps to ensure a vacuum, and provides a way of making angular adjustments of the mirrors 14 by positioning adjustment screws 18, as shown in FIG. 1A, to adjust the angular position of the mirror holding posts.

The o-ring vacuum seal between the flat surfaces of the end flanges 12 and the surfaces of the aluminum extrusion 10 in various present CO₂ laser products is provided by one of two designs: a single groove design of the type shown in FIGS. 1B and 1C, or an alternative double groove design of the type shown in FIGS. 1D and 1E. In both of these prior art designs, and as discussed above, a properly sized Indium o-ring 16 is placed into a groove that is machined either into the flange 12 as per FIGS. 1B and 1C (the single groove design), or into a groove machined into both the flange 12 and the aluminum extrusion 10 as per FIGS. 1D and 1E (the double groove design).

One problem experienced with these prior art designs is that the sealant material (e.g., Indium) is often extruded out between the mating parts, as shown in FIGS. 1C and 1E. This extrusion of the sealant between the flat mating parts of the flange 12 and the extrusion 10 creates a gap 20 between the end flange 12 and the aluminum extrusion 10 mating parts (as identified in FIG. 1A). The relative motion that can occur between the flanges 12 and their adjacent aluminum extrusion surfaces, as well as between the flanges 12 on each end of the extrusion 10 can lead to misalignment of the laser resonator, which degrades the performance of the laser over time. The relative motion between the resonator mirrors is caused by the laser heating up and cooling down as the laser is turned on and off, and also by the continuous force squeezing together flange 12 and extrusion housing 10 by bolts 21, thereby causing the soft sealant material to experience “creeping” or flow. Creping also can occur during the manufacturing bake-out process.

### BRIEF DESCRIPTION OF THE DRAWINGS

FIG. 1A is a partial-cross section view illustrating a typical prior art joint seal configuration.

FIGS. 1B-1E show seal material extruded out between mating parts in various prior art seal joint configurations.

FIG. 2A is a partial cross section view illustrating a typical seal joint configuration in accordance with the present invention.

FIGS. 2B-2G shows various seal joint configurations in accordance with the present invention.

FIG. 2H is an exploded view illustrating the mirror holding end flanges with the extruded laser housing and including an embodiment of a tongue and groove seal in accordance with the concepts of the present invention.

FIG. 3 shows typical dimensions for a thermally stable vacuum enclosure seal, tongue in groove design, in accordance with the present invention.

### DETAILED DESCRIPTION OF THE INVENTION

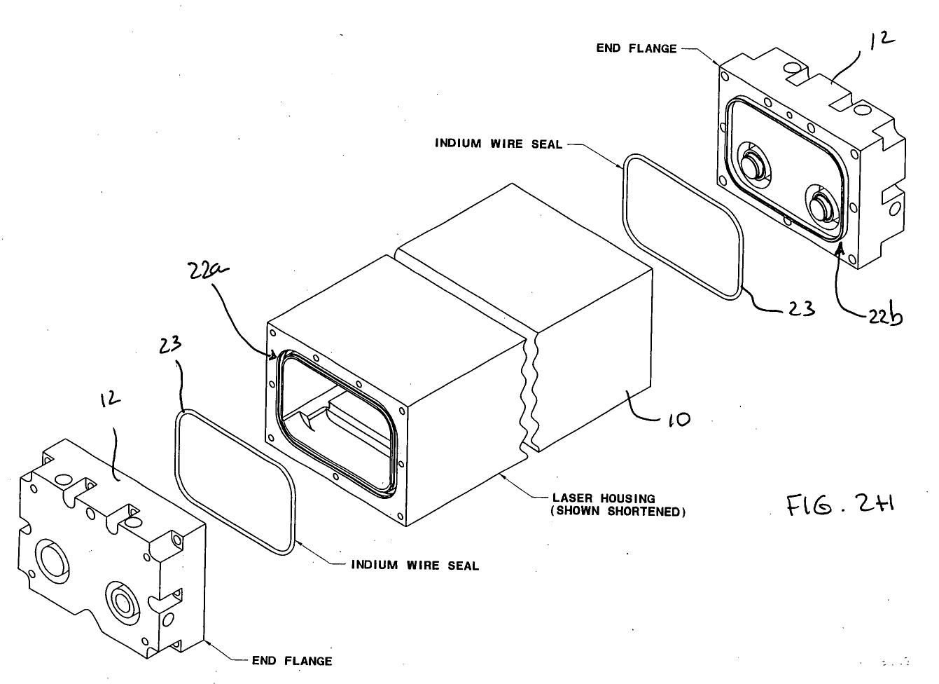

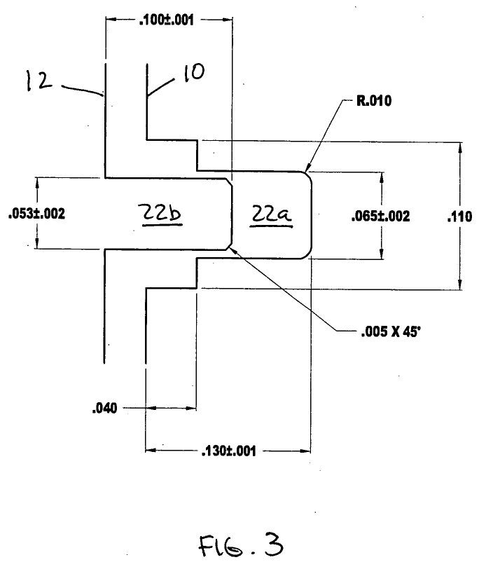

Systems and methods in accordance with various embodiments of the present invention can overcome these and other deficiencies in the prior art. For instance, a design in accordance with an embodiment of the invention utilizes a “tongue and groove” machined seal to improve the reliability and quality of a CO₂ laser product. FIG. 2A shows an example of such a tongue and groove design 22, with specific exemplary designs providing a thermally stable vacuum enclosure seal being illustrated in FIGS. 2B-2G.

In accordance with the FIG. 2A embodiment of the invention, a double groove 22a, that includes a primary seal area and a larger overfill groove, is machined into the end of the aluminum extrusion 10. A properly sized o-ring sealant 23, such as a sealant containing Indium, is placed within the deepest part (primary seal area) of the double groove 22a, as shown in FIGS. 2B, 2D and 2F. The tongue 22b is machined onto the flat surface of the mirror end flange 12 and placed into the double groove 22a of the extrusion 10. The dimensions of the tongue 22b are smaller than those of the groove 22a, leaving room for the extruded sealant to fill the overfill groove space between the tongue 22b and groove 22a. The sealant thereby provides a hermetic seal. An alternate design variation, without detracting from the concepts of the invention, is to reverse the tongue and groove design, i.e., to form the tongue on the extrusion housing 10 and the groove on the end flange 12.

FIGS. 2B and 2C illustrate a minimum fill condition that still provides a good hermetic seal. In the cases of FIGS. 2C, 2E and 2G, the flat surfaces of the flange 12 and the aluminum extrusion 10 are mated together without a space between them, thereby preventing relative motion between the two end flanges 12 that can result in a corresponding misalignment of the resonator mirrors with time (due to material creeping in the Indium) or temperature cycling (which can cause softening of the Indium o-ring at elevated temperatures).

FIGS. 2D and 2E illustrate the extent to which the sealant can be extruded in a nominal fill condition. Again, the two parts, i.e., extrusion 10 and end flange 12, are fully mated together in the FIG. 2E illustration.

FIGS. 2F and 2G, on the other hand, illustrate the extent to which the sealant can be extruded in a maximum fill condition. The diameter of the largest of the double grooves is chosen to be large enough to avoid being over-filled by the sealant, based on maximum tolerances placed on the size of the o-ring material. The double groove design ensures that the flat surfaces of the flanges 12 and the aluminum extrusion 10 are fully mated together under these over-fill conditions, as shown in FIG. 2G.

FIG. 2H shows an exploded view of the mirror holding end flanges 12 and its mating with the extruded laser housing 10, with the tongue 22b formed on the end flange 12 and the groove 22a formed on the housing 10, in accordance with the concepts of the present invention.

FIG. 3 provides exemplary dimensions for a tongue/groove vacuum seal in accordance with an embodiment of the invention. A 0.006 inch spacing between the outer diameter of the tongue 22b and the inner diameter of the smaller (primary seal area) of the two grooves is sufficient to provide a good seal for this embodiment. A 0.030 inch separation between the tip of the tongue 22b and the bottom of the deeper of the two grooves, when the adjacent flat surfaces of the flange 12 and the aluminum extrusion 10 are pressed against each other, is sufficient for a good seal.

While the shape of the Indium o-ring shown in the figures is round, those skilled in the art will understand that other shapes (such as flat Indium o-rings) are also acceptable. It also is possible to use sealants other than o-rings, and materials that do not contain Indium, as long as a proper thermally-stable, hermetic seal is formed and the sealant does not adversely affect laser operation. Other shapes (such as a point or knife edge) can also be used for the tongue, as can dimensions other than those discussed with respect to FIG. 3.

The sealing capability of a tongue and groove design such as is shown in FIGS. 2A-2H and FIG. 3 was examined using two separate rectangular-shaped test fixtures consisting of a rectangular flange with a tongue and a mating hollow rectangular aluminum extrusion chamber housing having a double groove machined in each end (as shown in FIGS. 2A-2G and FIG. 3). The two test fixtures were assembled and tested by two separate individuals. The fixtures were cleaned, assembled, and filled with He gas and elevated to 140° C. for two days to simulate the bake-out manufacturing procedure. Both were successfully He leak checked without trace of leakage along the perimeter of the rectangular shaped seal. The fixtures were then immersed in liquid N₂ (at a temperature of 77° K) until boiling of the liquid N₂ stopped. The temperature of the units was then raised to room temperature by running warm tap water over the units for approximately five minutes. Again, a Helium leak check indicated no leakage along the seal.

The two fixtures were hot soaked for two days at 140° C. in order to also determine whether an oxidation process (over time) at this temperature would occur and disrupt the seal. The fixtures were again brought back to room temperature by running tap water over them for five minutes. A He leak check again showed no leaks along the seal perimeter.

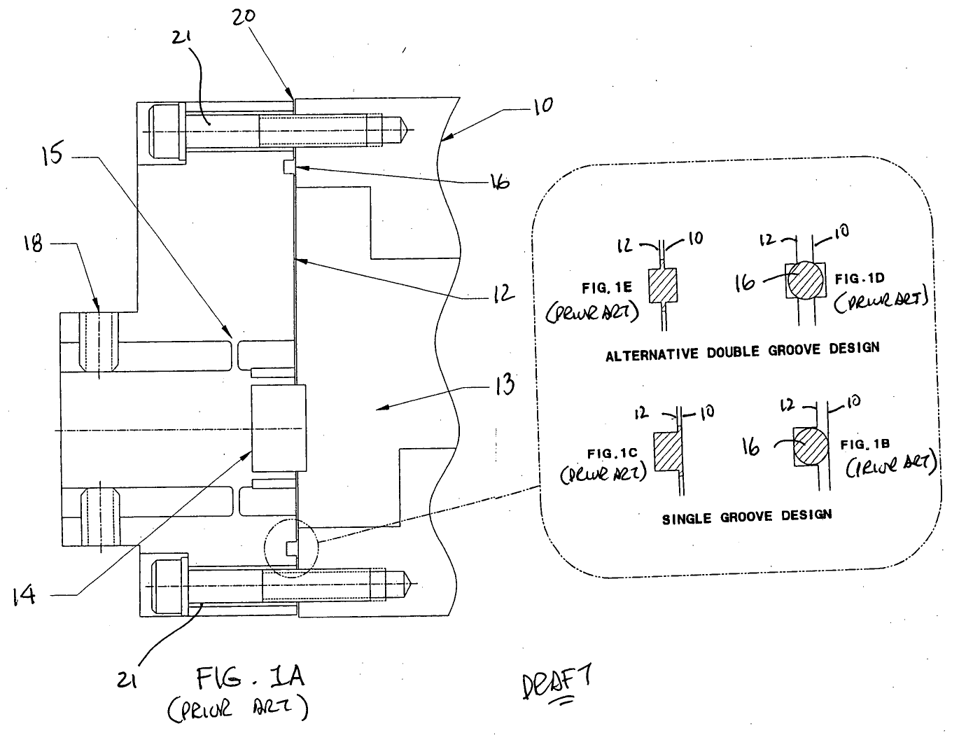

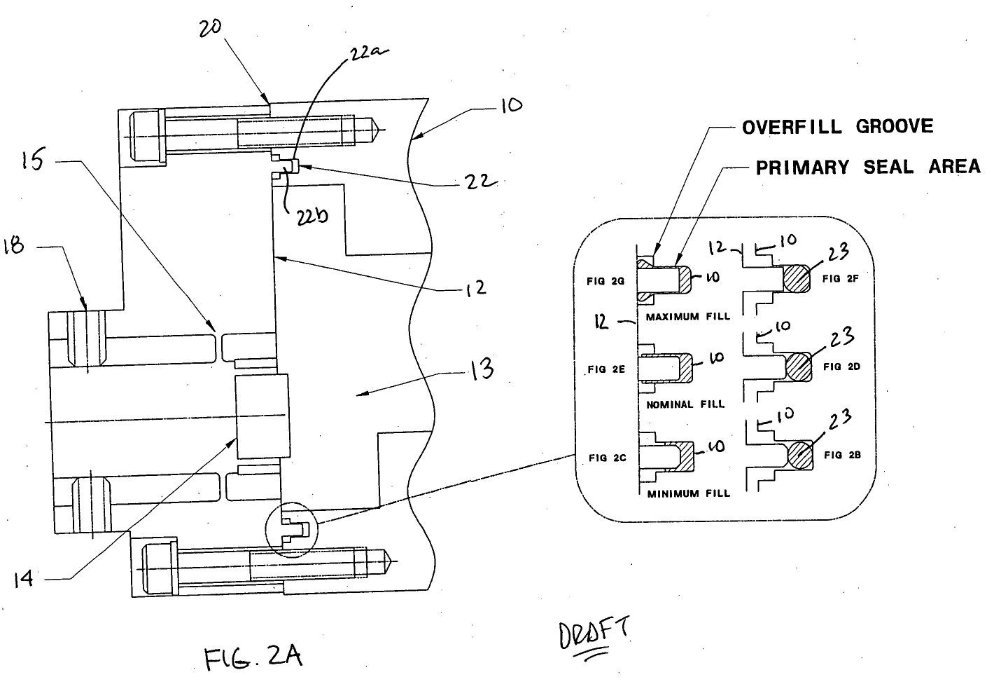

The two fixtures were disassembled to determine the degree of difficulty of accomplishing a typical laser housing repair. The disassembly was found to be easier than disassembly of the prior art design of FIG. 1. Upon inspection, no damage was found to have occurred to the tongue.

The Indium was removed from the tongue and groove using plastic and wooden scrapers. All parts were again cleaned and re-assembled using a new Indium o-ring. The fixtures again passed the He leak check tests. This test indicates that, disassembly and re-assembly of the hermetically sealed laser housing was easier than for the presently used design.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A sealing system for a laser device, the sealing system comprising:
a first member having a groove formed therein; and
a second member that includes a tongue that is received by the groove; and
a sealant positioned between the tongue and groove to provide a hermetic seal between the first and second members such that the first and second members define a sealed gas plenum for a laser device.

2. A sealing system as in claim 1, and wherein the groove comprises a first wider portion and a second narrower portion, the sealant being positioned in the second narrower portion.

3. A sealing system as in claim 2, and wherein the tongue is more narrow than the second narrower portion of the groove such that the sealant fills in at a least a portion of open space between the tongue and the groove.

4. An enclosure system for a laser device, the enclosure system comprising:
a housing having a perimeter portion that defines an interior open space, the perimeter portion having at least one end having a groove formed therein;
a flange member including a tongue shaped to be received by the groove of the perimeter portion of the housing in order to cap the housing; and
a sealant positioned between the groove of the housing and the tongue of the flange member in order to provide a hermetically sealed enclosure.

5. An enclosure as in claim 4, and wherein:
the groove is a double groove having a first wider portion and a second portion that is narrower than the wider portion.

6. An enclosure as in claim 5, and wherein:
the tongue is shaped to be at least partially received by the second narrower portion of the groove.

7. An enclosure as in claim 6, and wherein:
the sealant is positioned in the second narrower portion of the groove.

8. An enclosure as in claim 6, and wherein:
the tongue is more narrow than the second narrower portion of the groove, such that when the sealant is placed in the groove the sealant fills in at least a portion of open space between the tongue and the groove.

9. An enclosure as in claim 4, and wherein the housing comprises an aluminum extrusion.

10. An enclosure as in claim 4, and wherein the housing is adapted to contain elements selected from electrodes, inductors and laser gas mixtures.

11. An enclosure as in claim 4, and wherein the housing comprises one of a circular tube, a hollow rectangle and square bar-like configuration.

12. An enclosure as in claim 4, and wherein the flange member comprises an aluminum flange member.

13. An enclosure as in claim 4, and further comprising:
at least one mirror attached to the flange member.

14. An enclosure as in claim 4, and wherein the sealant comprises a metal o-ring.

15. An enclosure as in claim 4, and wherein the sealant contains Indium.

16. A method of hermetically sealing a gas plenum for a laser device, the method comprising:
placing sealant in a groove formed in a first member;
placing a tongue formed a second member into the groove formed in the first member to provide a hermetic seal between the first member and the second member such that the first and second members define a sealed gas plenum for a laser device.

17. A method as in claim 16, and wherein the groove comprises a first wider portion and a second narrower portion, the sealant being placed in the second narrower portion.

18. A method as in claim 17, and wherein the tongue is more narrow than the second narrower portion of the groove such that the sealant fills in at least a portion of open space between the tongue and the groove.

19. A method as in claim 16, and wherein the sealant comprises an o-ring.

20. A method as in claim 16, and wherein the sealant contains Indium.

21. A method for hermetically sealing an enclosure for a laser device, the method comprising:
placing a sealant in a groove formed in an end of a perimeter portion of a housing that defines an interior open space; and
placing a tongue formed on a flange member into the groove of the housing to cap the interior open space of the housing, the sealant forcibly contacting the tongue and the groove to provide a hermetically sealed gas plenum for a laser device.

22. A method as in claim 21, and wherein:
the groove includes a first wider portion and a second narrower portion;
the step of placing the sealant in the groove includes placing the sealant in the second narrower portion of the groove; and
the step of placing the tongue into the groove includes placing at least a portion of the tongue into the second narrower portion of the groove.
